(19) United States
(12) Patent Application Publication
(10) Pub. No.: US 2022/0382769 A1
(43) Pub. Date: Dec. 1, 2022

(54) Judgment Search System

(71) Applicant: Judgment Search Network, LLC, Neptune, NJ (US)

(72) Inventors: Kwan Skinner, Neptune City, NJ (US); Dolores Dios, Neptune, NJ (US); Lloyd Glick, Neptune, NJ (US); Scott O'Neill, Neptune, NJ (US); Christopher Blum, Neptune, NJ (US); Phill Davis, Neptune, NJ (US)

(73) Assignee: Judgment Search Network, LLC, Neptune, NJ (US)

(21) Appl. No.: 17/825,273

(22) Filed: May 26, 2022

Related U.S. Application Data
(60) Provisional application No. 63/193,298, filed on May 26, 2021.

(51) Int. Cl. G06F 16/2457; G06Q 50/18

(52) U.S. Cl. CPC G06F 16/24578; G06Q 50/18

(57) ABSTRACT

The present disclosure provides systems and methods for performing a search query based on one or more search terms and variations for each of the search terms and outputting the search results in a sortable, filterable, manipulable format. A search request, based on the search query, may be sent to at least one server. Each of the search terms and variations thereof may be assigned different weights. The results may include one or more matches to the search terms and variations thereof. The results may be sorted based on the weights assigned to each of the search terms and variations thereof. The results may be output to be viewed, sorted, filtered, or manipulated by a user.

### CROSS-REFERENCE TO RELATED APPLICATIONS

The present application claims the benefit of the filing date of U.S. Provisional Patent Application No. 63/193,298 filed May 26, 2021, the disclosure of which is hereby incorporated herein by reference.

### BACKGROUND

Judgments entered by a court or agency against a person may be searched. The person may be identified as a debtor. The search may result in a hard copy or stagnant copy of the search results, leaving a user to read through tens, hundreds, or even thousands of search results that are set forth in no particular order. Many of the search results may be irrelevant. In some instances, the search results may not include the information of interest if the debtor's name was not entered correctly by the court and/or agency or if the user does not know the correct spelling of the debtor's name. Thus, there is a need to improve the search to improve completeness of the search as well as a way to manipulate the search results to allow a user to more easily sort through the information provided in response to the search.

### BRIEF SUMMARY

The present disclosure provides systems and methods for searching databases and receiving, in response to the search, an output that is sortable, filterable, and/or manipulable. In particular, the systems and methods described herein are related to receiving a search query from a user. The search query may include one or more search terms. A search request may be sent to a server based on the search query. The search request may include the one or more search terms and variations of each of those search terms. Different weights may be assigned to the search terms and/or variations thereof. The results of the search request may include a match of the search terms and/or variations thereof. The results may be sorted based on the weights assigned to the search results. The sorted search results may be output to a user to be further sorted, filtered, or manipulated for each of use by the user.

One aspect of the disclosure is directed to a method comprising receiving, by one or more processors, a search query including one or more terms associated with one or more inputs from a user, sending, by the one or more processors, a search request, derived from the search query, to at least one database server, wherein the search request includes one or more variations for each of the terms in the search query, wherein a first input of the one or more inputs has a first weight and a second input of the one or more inputs has a second weight, the first weight being greater than the second weight, wherein a first term of the one or more terms has a first score and a first variation of the first term has a second score, the first score being greater than the second score, and wherein when the second score of the first variation is above a predetermined threshold, the first variation is included in the search request, receiving, by the one or more processors from the at least one database server, a response to the search request including one or more search results, wherein the one or more search results includes a match to the one or more terms in the search query, sorting, by the one or more processors based on the first and second weights, the one or more search results, and outputting, by the one or more processors, the sorted one or more search results.

Sending the search request to the at least one database server may include sending, by the one or more processors, the search request to a first database server, receiving, from the first database server, a first set of search results, wherein the first set of search results are used as input as a second search request at a second database server, and receiving, by the one or more processors from the second database server, the response to the search request.

The one or more terms may include a first name and a last name of a person of interest. The last name of the person of interest may have a greater weight than the first name of the person of interest. The first name and the last name of the person of interest input into the search query may have a greater weight than each of the variations of the first name and last name of the person of interest.

Sending the search request to the at least one database server may include sending, by the one or more processors, the search request to a first database server, the search request including the first name and the last name of the person of interest and each of the variations of the first name and last name of the person of interest, receiving, from the first database server, a first set of search results including the first name and last name of the person of interest, each of the variations of the first name and last name of the person of interest, and a judgment amount associated with the first name, last name, and each of the variations of the first name and last name of the person of interest, wherein the first set of search results are used as input as a second search request at a second database server, and receiving, by the one or more processors from the second database server, a second set of search results including two or more of a filing location, a filing date, a case title, a docket number, a judgment number, a judgment type, and a judgment amount associated with the first name, last name, and each of the variations of the first name and last name of the person of interest, wherein the second set of search results corresponds to the one or more search result.

The method may further comprise receiving, by the one or more processors, a user input to resort or filter the sorted one or more search results. The output sorted one or more search results may be output as a spreadsheet, a portable document format document, or a text document. The sorted one or more search results may include at least one of a name of a person of interest, an address of the person of interest, a filing location, a filing date, a case title, a docket number, a judgment number, a judgment type, or a judgment amount.

Another aspect of the disclosure is a device comprising one or more processors configured to receive a search query including one or more terms associated with one or more inputs from a user, send a search request, derived from the search query, to at least one database server, wherein the search request includes one or more variations for each of the terms in the search query, wherein a first input of the one or more inputs has a first weight and a second input of the one or more inputs has a second weight, the first weight being greater than the second weight, wherein a first term of the one or more terms has a first score and a first variation of the first term has a second score, the first score being greater than the second score, and wherein when the second score of the first variation is above a predetermined threshold, the first variation is included in the search request, receive, from the at least one database server, a response to the search request including one or more search results, wherein the one or more search results includes a match to the one or more terms in the search query, sort, based on the first and second weights, the one or more search results, and output, to a display, the sorted one or more search results.

Yet another aspect of the disclosure is a method comprising receiving, by one or more processors, a search request including one or more terms, reformulating, by the one or more processors, the search request into a search query including the one or more terms and one or more variations for each of the terms, querying, by the one or more processors, a first database using the search query, wherein each of the one or more terms and each of the one or more variations is assigned a score, and wherein each of the one or more terms is a type of term, each type of terms is assigned a weight, receiving, by the one or more processors based on the score of each of the one or more terms and variations and the weight of each of the type of terms, a first output of first results from the query of the first database, querying, by the one or more processors, a second database using the first output as input into the query of the second database, sorting, by the one or more processors based on the score of each of the one or more terms and variations and the weight of each of the type of terms, second results from the query of the second database, and outputting, by the one or more processors, the sorted second results.

The one or more terms may include a first name and a last name of a person of interest. The last name of the person of interest may have a greater weight than the first name of the person of interest. The first name and the last name of the person of interest may have a greater score than each of the variations of the first name and last name of the person of interest. The one or more terms may include a first name and a last name of a person of interest and the sorted second results includes a judgment against the person of interest. The sorted second results may be output as a spreadsheet, a portable document format document, or a text document. The sorted second results may include at least one of a name of a person of interest, an address of the person of interest, a filing location, a filing date, a case title, a docket number, a judgment number, a judgment type, or a judgment amount.

Another aspect of the disclosure is directed to a device, comprising one or more processors configured to receive a search request including one or more terms, reformulate the search request into a search query including the one or more terms and one or more variations for each of the terms, query a first database using the search query, wherein each of the one or more terms and each of the one or more variations is assigned a score, and wherein each of the one or more terms is a type of term, each type of terms is assigned a weight, receive, based on the score of each of the one or more terms and variations and the weight of each of the type of terms, a first output of first results from the query of the first database, query a second database using the first output as input into the query of the second database, sort, based on the score of each of the one or more terms and variations and the weight of each of the type of terms, second results from the query of the second database, and output the sorted second results.

### BRIEF DESCRIPTION OF THE DRAWINGS

FIG. 1 is a block diagram illustrating an example device according to aspects of the disclosure.

FIG. 2 is a functional diagram of an example system according to aspects of the disclosure.

FIG. 3 illustrates an example display screen for performing a new search according to aspects of the disclosure.

FIGS. 4A-5 illustrates example outputs of search results according to aspects of the disclosure.

FIG. 6 illustrates an example cover sheet according to aspects of the disclosure.

FIG. 7 illustrates an example display screen showing previous searches according to aspects of the disclosure.

FIG. 8 is a flow diagram according to aspects of the disclosure.

FIG. 9 is a flow diagram according to aspects of the disclosure.

### DETAILED DESCRIPTION

The present disclosure relates to systems and methods that provide searches using variations of search terms and provide search results that can be manipulated, filtered, and/or sorted by a user. The improved search method may provide for a more inclusive and/or encompassing search relating to a person of interest by incorporating known and/or common variations of a debtor's name. The search may also include known and/or common misspellings of a debtor's name. The search results may be returned to a user in a way such that the results are able to be filtered, sorted, and/or manipulated by the user to provide the user with an efficient way to identify pertinent information.

The search results may relate to judgments granted by various courts or agencies. For example, when searching for judgments in New Jersey, the search results may include judgments entered by Superior Courts, Bankruptcy Court, Probation, Child Support, Public Defenders, Motor Vehicle Commission, Patriot List, etc. When searching for judgments in other states, the courts and/or agencies being search may include the same, similar, or the equivalent courts and/or agencies.

The judgment may be against a person of interest, such as a debtor. A user may want to identify judgments against a debtor. The user, however, may not know the exact spelling of the debtor's name, the debtor's name may be incorrectly entered by the court or agency, etc. Thus, variations of the debtor's name as entered by the user must be searched to provide the user accurate search results.

According to some examples, the search may be performed by searching two databases. The two databases may be located on two different platforms. The first database may be used to perform a fast search. The fast search may search the name of the debtor, as entered by the user, and the likely variations of the debtor's name to identify any judgments pertaining to the debtor's name and name variations. The results from the fast search may then be used as input as a search for the second database. The second database may be searched to provide additional details pertaining to the debtor and/or judgment. For example, the results from searching the second database may include the name of the debtor, the judgment amount, the judgment number, the docket number, the court and/or agency the judgment was entered by, the date of birth of the debtor, the address of the debtor, the filing location of the case and/or matter, the filing date of the case and/or matter, the matter and/or case title, the judgment type, etc. According to some examples, some of these search results may have been identified in response to the fast search of the first database. By performing the search using two databases, the search may be completed faster and/or more efficiently than if performed using a single database, given the large number of records stored in the system.

The results from the search may be output to the user in one or more formats. For example, the results may be output as a searchable portable document format (“PDF”) or text document. According to some examples, the results may be output as a spreadsheet. The spreadsheet may allow the user to search, filter, sort, and/or manipulate the search results. For example, the user may sort the results by judgment date if the user is interest in the most recent judgments against a debtor. In some examples, the user may sort the results by the judgment type if the user is most interested in identifying what types of debt the debtor has. According to some examples, the results may be output as a hard copy, such as a printout. This hard copy of the results may be mailed or sent to the user.

By outputting the results in a searchable, filterable, sortable, and/or manipulable format, the user may be able to more quickly find the information they are looking for as compared to reviewing the results as a hard copy print out. Moreover, by expanding the results to include variations of the debtor's name as entered by the user, the user will be provided with more complete results that the user may have otherwise missed due to spelling errors on behalf of the user, the court, and/or agency.

### Example Systems

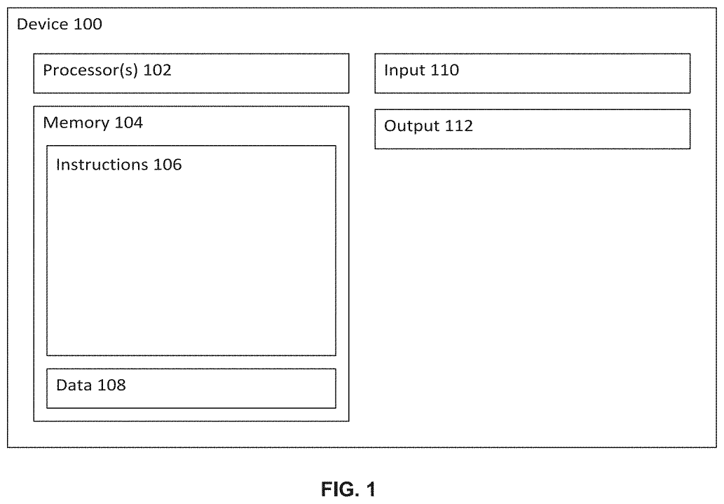

FIG. 1 provides an example block diagram illustrating components of the device. As shown, the device 100 includes various components, such as one or more processors 102, memory 104, and other components typically present in microprocessors, general purpose computers, or the like. Device 100 also includes input 110 and an output 112.

The one or more processors 102 may be any conventional processors, such as commercially available microprocessors. Alternatively, the one or more processors may be a dedicated device such as an application specific integrated circuit (ASIC) or other hardware-based processor. Although FIG. 1 functionally illustrates the processor, memory, and other elements of device 100 as being within the same block, it will be understood by those of ordinary skill in the art that the processor, computing device, or memory may actually include multiple processors, computing devices, or memories that may or may not be stored within the same physical housing. Similarly, the memory may be a hard drive or other storage media located in a housing different from that of device 100. Accordingly, references to a processor or computing device will be understood to include references to a collection of processors or computing devices or memories that may or may not operate in parallel.

Memory 104 may store information that is accessible by the processors 102, including instructions 106 that may be executed by the processors 102, and data 108. The memory 104 may be of a type of memory operative to store information accessible by the processors 102, including a non-transitory computer-readable medium, or other medium that stores data that may be read with the aid of an electronic device, such as a hard-drive, memory card, read-only memory (“ROM”), random access memory (“RAM”), optical disks, as well as other write-capable and read-only memories. The subject matter disclosed herein may include different combinations of the foregoing, whereby different portions of the instructions 106 and data 108 are stored on different types of media.

Data 108 may be retrieved, stored or modified by processors 102 in accordance with the instructions 106. For instance, although the present disclosure is not limited by a particular data structure, the data 108 may be stored in computer registers, in a relational database as a table having a plurality of different fields and records, XML documents, or flat files. The data 108 may also be formatted in a computer-readable format such as, but not limited to, binary values, ASCII or Unicode. By further way of example only, the data 108 may be stored as bitmaps comprised of pixels that are stored in compressed or uncompressed, or various image formats (e.g., JPEG), vector-based formats (e.g., SVG) or computer instructions for drawing graphics. Moreover, the data 108 may comprise information sufficient to identify the relevant information, such as numbers, descriptive text, proprietary codes, pointers, references to data stored in other memories (including other network locations) or information that is used by a function to calculate the relevant data.

The instructions 106 can be any set of instructions to be executed directly, such as machine code, or indirectly, such as scripts, by the processor 102. In that regard, the terms “instructions,” “application,” “steps,” and “programs” can be used interchangeably herein. The instructions can be stored in object code format for direct processing by the processor, or in any other computing device language including scripts or collections of independent source code modules that are interpreted on demand or compiled in advance. Functions, methods and routines of the instructions are explained in more detail below.

The device 100 may further include an input 110. The input 110 may be, for example, a touch sensor, dial, button, or other control for receiving a manual command. The input 110 may, in some examples, be a microphone or keyboard. The device 100 may also include an output 120. The output 120 may be, for example, a display.

It should be understood that the device 100 may include other components which are not shown, such as a battery, charging input for the battery, signals processing components, etc. Such components may also be utilized in execution of the instructions 106.

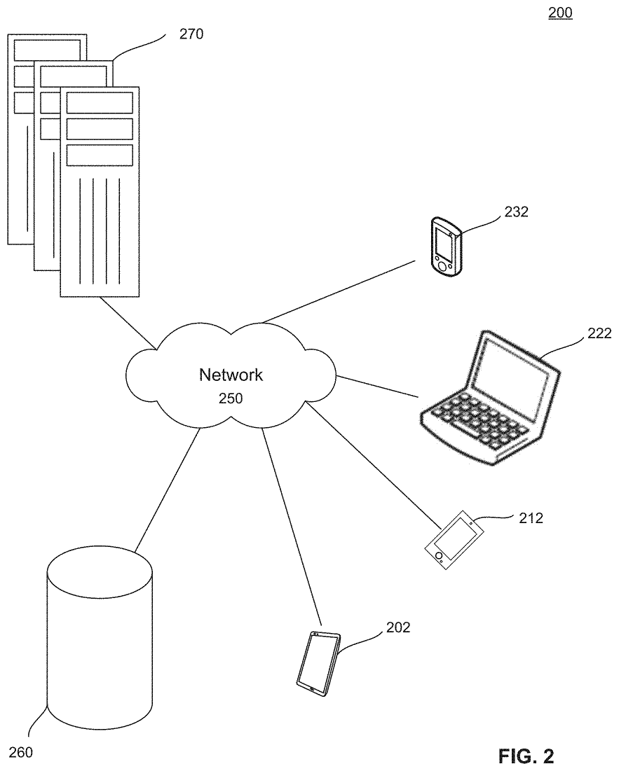

FIG. 2 illustrates an example system 200 in which the features described herein may be implemented. It should not be considered limiting the scope of the disclosure or usefulness of the features described herein. In this example, system 200 may include a plurality of devices 202, 212, 222, 232, server computing device 270, storage system 260, and network 250. For purposes of ease, the collection of devices 202, 212, 222, 232 or a single device will be referenced as device(s) 202. Each device 202 may be a personal computing device intended for use by a respective user 204 and have all of the components normally used in connection with a personal computing device, as described above with relationship to device 100, including a one or more processors (e.g., a central processing unit (CPU)), memory (e.g., RAM and internal hard drives) storing data and instructions, a display (e.g., a monitor having a screen, a touch-screen, a projector, a television, or other device such as a smart watch display that is operable to display information), and user input devices (e.g., a mouse, keyboard, touchscreen or microphone). The devices 202 may also include a camera, speakers, a network interface device, and all of the components used for connecting these elements to one another. Device 202 may be capable of wirelessly exchanging and/or obtaining data over the network 250.

Although the devices 202 may each comprise mobile computing devices capable of wirelessly exchanging data with a server over a network such as the Internet, they may alternatively comprise a full-sized personal computing device, such as laptop 222. By way of example only, devices may be mobile phones or devices such as a wireless-enabled PDA 232, a smartphone 212, a tablet PC 202, a wearable computing device (e.g., a smartwatch, headset, smartglasses, virtual reality player, other head-mounted display, etc.), or a netbook that is capable of obtaining information via the Internet or other networks.

The devices 202 may be at various nodes of a network 250 and capable of directly and indirectly communicating with other nodes of network 250. Although four (4) devices are depicted in FIG. 2, it should be appreciated that a typical system 200 can include one or more devices, with each computing device being at a different node of network 250. The network 250 and intervening nodes described herein can be interconnected using various protocols and systems, such that the network can be part of the Internet, World Wide Web, specific intranets, wide area networks, or local networks. The network 250 can utilize standard communications protocols, such as WiFi, that are proprietary to one or more companies. Although certain advantages are obtained when information is transmitted or received as noted above, other aspects of the subject matter described herein are not limited to any particular manner of transmission.

In one example, system 200 may include one or more server computing devices having a plurality of computing devices, e.g., a load balanced server farm, that exchange information with different nodes of a network for the purpose of receiving, processing and transmitting the data to and from other computing devices. For instance, one or more server computing devices 270 may be a web server that is capable of communicating with the one or more devices 202 via the network 250. In addition, server computing device 270 may use network 250 to transmit and present information to a user 204 of one of the other devices 202. Server computing device 270 may include one or more processors, memory, instructions, and data. These components operate in the same or similar fashion as those described above with respect to device 100.

Storage system 260 may store various types of information. For instance, the storage system 260 may store information about judgments entered by a court and/or agency. The storage system 260 may store judgment data. The judgment data may include, for instance, the name, address, and birthday of the debtor. The judgment data may also include the filing location, filing date, case title, docket number, judgment number, judgment type, judgment amount, etc. This information may be retrieved or otherwise accessed by a service computing device, such as one or more server computing devices 270, in order to perform some or all of the features described herein. While only one storage system 260 is shown, system 200 may include one or more storage systems 260.

### Example Methods

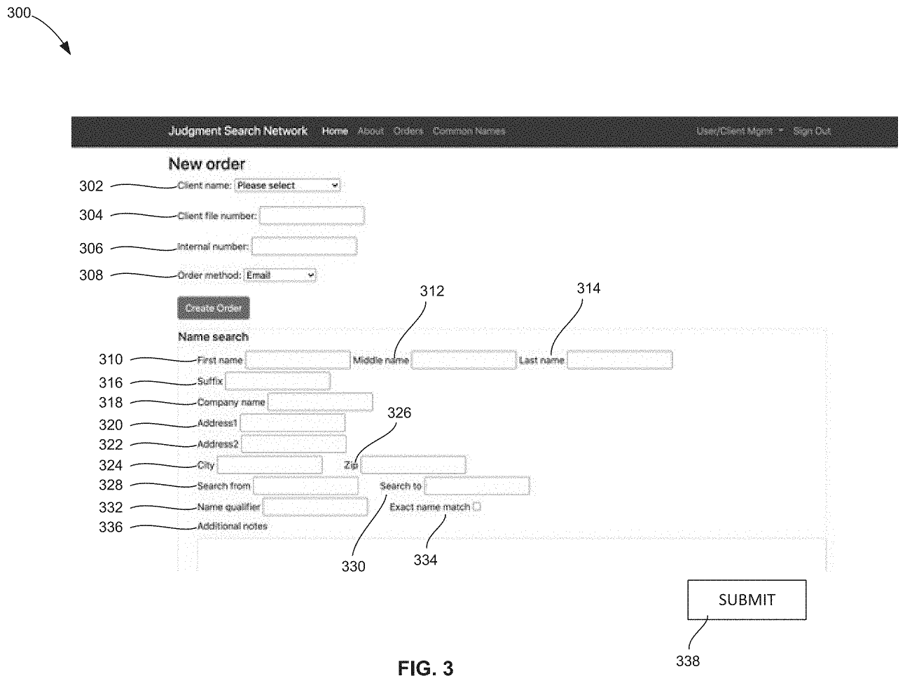

FIG. 3 illustrates an example display screen for performing a new search, or requesting a new order. For example, when a user may open an application, such as the Judgment Search Network. Upon opening the application, the user may be presented with screen 300 on the display of the user device. Screen 300 may include one or more inputs 302-336.

According to some examples, screen 300 may include inputs 302-308 that allow the user to enter information related to why the user is performing the search query. In some examples, inputs 302-308 may be used to enter information related to how the user is using the information. For example, the user may be performing the search on behalf of a client. In such an example, the user may input information regarding the client name 302, file number 304, internal number 306, and/or order method 308. The inputs for client name 302, file number 304, internal number 306, and/or order method 308 are only some examples of the information that may be entered by a user and are not intended to be limiting regarding the information that can be entered by a user.

To create a search query, the user may input one or more search terms into one or more inputs 310-336. Inputs 302-336 may include the first name 310, middle name 312, last name 314, suffix 316, company name 318, address 320, 322, city 324, and zip code 326 of the person of interest that the user is searching. According to some example, the person of interest may be a debtor. The user may, additionally or alternatively, enter search terms into inputs 328-336, which correspond to a search from date 328, search to date 330, name qualifier 332, an option to only show exact name matches 334, and additional notes 336. Name qualifier input 332 may allow a user to enter “Jr.,” “II,” “III” etc. as an additional qualifier for the name of the person of interest. According to some examples, entering information into name qualifier input 332 may further reduce the number of names matched by the system. The inputs 310-336 are only some examples of the information that can be entered by a user and be used as one or more terms in a search query. Thus, the examples shown in screen 300 are not intended to be limiting.

A user may enter information into one or more inputs 310-336. The user may then select submit 338 to create a search query. The information entered into inputs 310-336 may then be used as one or more search terms in a search query. A search request derived from the search query may be send to one or more servers.

The search request may include one or more variations of the information entered into inputs 310-336. For example, a user may enter “John” into input 310 and “Smith” into input 314. The search request may include one or more variations on each of “John” and “Smith.” For example, variations of “John” may include Jon, Jonathan, Johnathan, Jonathon, etc. and variations of “Smith” may include Smyth, Smithe, Smythe, etc. Thus the search request will include “John” and “Smith” as well as the variations of “John” and “Smith.”

The variations of information entered into inputs 310-336 may include alternative spellings, likely misspellings, the inclusion or lack thereof punctuation, such as a hyphen or apostrophe, etc. of the information. According to some examples, the variations of information entered into inputs 310-336 may be stored in storage system 260 and accessed by servers 270 in response to a search request.

The search request may assign different weights to each of the inputs 310-336. For example, a first weight may be assigned to first name input 310 and a second weight may be assigned to last name input 314. The second weight, or the weight assigned to the last name input 314, may be more than the first weight, or the weight assigned to the first name input 310.

In some examples, the weight assigned to the first name input 310 or last name 314 may be reduced to a minimum threshold in order to capture high risk judgments where the risk level is pre-determined by the end user.

According to some examples, each of the variations of the inputs may be assigned a score, or weight. For example, the information entered into last name input 314 may be given a score of 100, while the next most likely variation of the information entered into last name input 314 may be given a score of 98. As the variations continue to more away from the information entered into last name input 314, the score of the variation may decrease. The search request may use only the information entered into last name input 314 and variations with a score greater than a predetermined threshold as part of the search request. In some examples, the predetermined threshold may be a weighted score of 80. However, the predetermined threshold of 80 is merely one example and is not intended to be limiting such that the threshold may be greater than or less than 80. Additionally, while the scores are discussed herein with respect to last name input 314, any of the information entered into inputs 310-336 may be weighted such that only the information entered into those inputs and variations above a predetermined threshold are used as part of the search request.

The weighting scheme applied to the information entered into first name input 310, last name input 314, middle name input 312, etc. may be a formula whereby the information entered into last name input 314 is matched and then weighted by some multiple more than the match of information entered into first name input 310. In such an example, this weighting function may be 3 times the score of the last name input 314 plus the score of the first name input 310 such that the cumulative score is at least 355. This cumulative score can vary in range from as little as 300 up to 800, with the preferred value being near the aforementioned score. The multiple of 3, cumulative score of 355, and range of 300 to 800 are merely examples and are not intended to be limiting. For example the multiple may be between 1-10, the cumulative score may by between 0-500, and the range may be between 100-1000. Moreover, while the weights are discussed as being applied to last name input 3114 and first name input 310, the weights may be applied to any inputs 310-336.

According to some examples, certain inputs 310-336 may be weighted more than others. For example, information entered into last name input 314 may be weighted more than information entered into first name input 310. Information input into first name input 310 may be weighted more than information entered into middle name input 312.

By assigning weights to a given input the results of the search request may be sorted and/or filtered to include only matches having a total weight above a predetermined threshold. Additionally or alternatively, by assigning scores to each of the variations of the information entered into the inputs, the results of the search request may be sorted and/or filtered to include only matches with the information entered and variations thereof above a predetermined threshold. This may provide the user with results that are most relevant to the information entered into inputs 310-336. Additionally, but searching only information and variations on the information that is above a predetermined threshold, the search results may be limited to a more manageable number of results. This will allow the user to more efficiently filter, sort, and review the information provided in the search results.

In response to the search request, the server may identify one or more results. For example, the server may be in communication with one or more storage systems 260 and/or servers 270. The search request may identify information that is saved in one or more storage systems 260. For example, the search request may search storage systems 260 associated with Superior Court, Bankruptcy Court, Probation, Child Support, Public Defenders and Motor Vehicle records, the Patriot List, and/or any other court or agency that enters a judgment against a person. These are just some examples of courts and agencies that may have information stored in storage systems 260 and the list is not intended to be limiting.

According to some examples, the search request may be sent to a first server that can perform fast lookups to find all known matches that should be considered further. For example, the first server may search the information entered into inputs 310-316 to identify and possible judgments the user may be interested in. The output of the fast lookup on the first server may be used as input for a search request to a second server. The second server may identify additional details related to the output of the fast lookup. For example, the second server may identify additional details that will be output as part of the report to the user, such as a filing location, a filing date, a case tile, a docket number, a judgment number, a judgment type, and/or a judgment amount.

In some examples, the first server may process a received search request by selecting information included in the search request to perform the fast search. For instance, the first server may select the first name, middle name, last name, and suffix to perform the fast search. The results of the fast search may then return only first name, middle name, last name, and suffix that matches the search request. Additionally or alternatively, the results of the fast search may include a judgment amount and/or number associated with the matched name. An aspect of the disclosed technology is performance of the fast search in a databases that contains information associated with only a limited amount of fields of those showed in FIG. 3. In the specific example discussed here, only first name, middle name, last name and suffix are used for fast search of database that only contains that type of information along with the judgment amount and/or number associated with the name information. That is, such database, e.g., as fast search database, would not include information about fields 318-334. This results in a lighter database and can be searched more quickly. For example, the first database, or the fast search database, may be a relational database. In some examples, the fast search database may be a document-based database that can perform full-text searches.

The results of the fast search may then be used to form a second search via a second server of a database that contains information about fields 310-334. However, because the number of potentially relevant database records have been limited as a result of the fast search, this search is more focused and may done more efficiently. For example, the judgment amount and/or number identified as part of the fast search may be used to identify additional relevant information during the second search. The additional relevant information may be additional details for that judgment. The additional details may be split across multiple tables in the second server of a database and/or second database. The search of the second database may identify the additional information and, in some examples, join the additional information into one or more search results to output to the user.

In the foregoing example, the search is discussed in relation to a first server and a second server. However, two servers are not necessary. For example, a single server may carry out both the fast and second searches by first processing the search request into a fast search and then using the results of the fast search to perform the second search. In addition, the data searched in the fast search and second search may be housed on different databases or on a single database that is partitioned to have a fast search area and second search area. In some examples, the data searched in the fast search and the second search may be housed on different systems or on a single system that is partitioned to have a fast search area and a second search area. More specifically, database 260 may comprise one or more databases that are queried as part of the search request or single database that includes a fast search area and more comprehensive search area. Further, the number of fields for which data is searched as a part of the fast search may be modified in accordance with the system design. For example, if too few fields are chosen the fast search may return too may results. On the other hand, if too many fields are chosen the fast search may take too much time.

Matches identified by the second server may be filtered and/or sorted based on user supplied criteria. The user supplied criteria may include information entered into inputs 310-336 and/or information entered when the user created an account with the Judgment Search Network application. For example, the user may have previously entered criteria that only results with judgments over $10,000 should be output. Thus, the second server may filter out any results with a judgment amount less than $10,000. In some examples, the user may have entered a date range into search from input 328 and search to input 330. The second server may filter out any results that are outside of that date range. In another example, the user may enter information into zip input 326 such that the results are limited to only debtors having an address in that zip code. The second server may filter the results based on any combination of criteria entered when an account was created and/or information entered into inputs 310-336. Therefore, the example provided herein are merely examples and are not intended to be limiting.

According to some examples, the second server may filter and/or sort the identified matches based on the weights assigned to the information entered inputs 310-336 and the scores for the variations thereof. For example, the second server may filter the search results based on the search terms entered into inputs 310-336. The results may be based on the weights assigned to each input 310-316. In some examples, information entered into last name input 314 may have a greater weight than information entered into first name input 310. In such an example, the filtered search results may include results that match the information entered into last name input 314 and/or a variation of the information entered into last name input 314 even if the first name of the result does not match the information entered into first name input 310.

According to some examples, the filtered search results may be based on the closest match to all the information. In such an example, the second server may filter the search results to include only results that match all information entered into inputs 310-336.

In yet another example, the second server may filter the results based on the weight given to each input 310-336. In some examples, the user may select or input which of inputs 310-336 should be given the most weight when filtering the search results. For example, the user may select zip code input 326 to be given the most weight, last name input 314 to be given the second most weight, search from input 328 and search to input 326 to be given to the third most weight, etc. Thus, the user can customize the filtering of the results based on the inputs 310-336 that are most important and/or relevant to their search. In another example, the weights of each input 310-336 may be predefined. For example, last name input 314 may be given the most weight, first name input 310 may be given the second most weight, zip code input 326 may be given the third most weight, etc. The order of the assigned weights described above are merely examples and are not intended to be limiting.

By filtering the results based on predetermined weights assigned to each of inputs 310-336 and/or selected by a user, the number of results output by the second server may be more manageable for the user to parse through to find the information they are looking for. For example, by applying weights

According to some examples, the user may select criteria when registering for an account and/or when beginning the search process to set a value of the judgment to be searched. For example, the user may set a minimum value of judgments to be searched. In some examples, when the minimum value is above a predetermined threshold, it may be determined that the search is for a “high value” judgment. For example, the predetermined threshold may be $7,500 such that, when the user sets the minimum value of the judgment to be $10,000, the search request is considered a high value search. However, the predetermined threshold may be more or less than $7,500. Accordingly, the threshold of $7,500 is merely one example and is not intended to be limiting.

In examples where it is determined that the user is performing a high value search, the search request may become a “fuzzy search.” A fuzzy search may lower the predetermined threshold for the weights assigned to inputs 310-336 and their variations. This may results in a greater number of search results that may have otherwise been excluded due to the weights assigned to inputs 310-336.

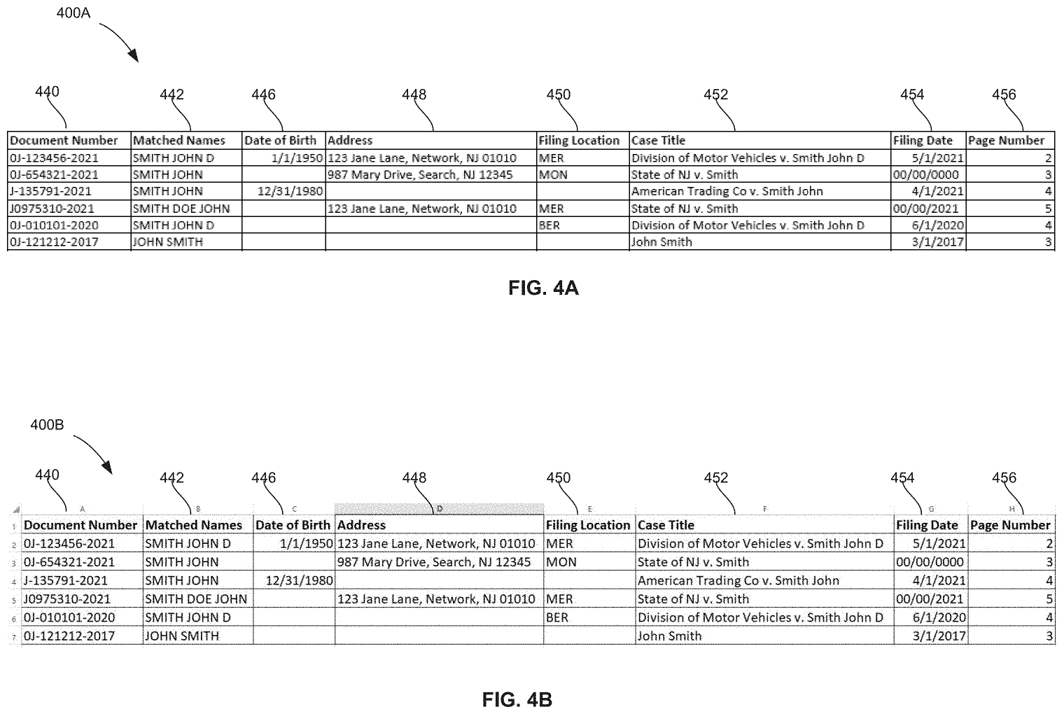

FIGS. 4A and 4B illustrate outputs of the search results identified by the servers in response to the search request. The search results may, in some examples, automatically be sorted based on user criteria. For example, when creating an account with the application, the user may have selected that the search results be presented based on the filing dates of the judgment with the most recent judgment on the top of the list. In some examples, the user may have selected that the results be presented based on the closest matched name to the information entered into inputs 310-336.

The results may include the document number 440 of the judgment, the matched names 442, the date of birth 446 of the person of interest or debtor, the address 448 of the person of interest, the filing location 450 of the judgment, the case title 452, the filing date 454, and the page number 456. The results may, additionally or alternatively, includes the judgment amount, the docket number, if different than the document number, the judgment type, etc.

FIG. 4A illustrates an output 400A in which the results are in searchable PDF or text format. According to some examples, output 400A may also correspond to what a user would receive if they opted for a hard copy, or a print out, of the results.

FIG. 4B illustrates an output 400B in which the results are in a spreadsheet that can be further sorted, filtered, or manipulated by the user. For example, the user may sort, filter, and/or manipulate the results by sorting and/or filtering any of columns A-H. In some examples, the user may sort column G, corresponding to the filing date 454, to identify the most recent judgments filed against the matched names 442. In some examples, the user may additionally or alternatively sort column E to alphabetize the filing location 450. The user may continue to sort any of columns A-H to organize the information in the most beneficial way for the user.

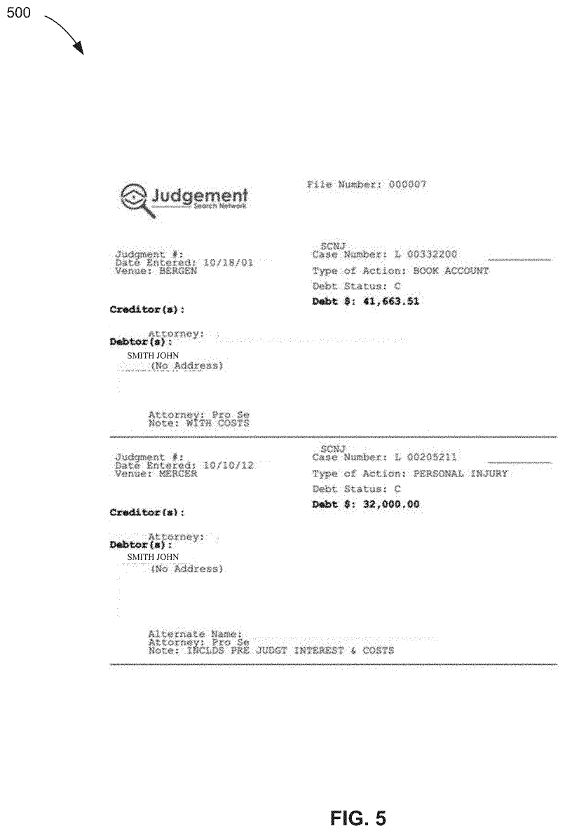

FIG. 5 illustrates an additional output 500 of the search results. According to some example, the output 500 may be the output provided as part of a searchable PDF or text document and/or a print out of the search results. Instead of organizing the information of the results in columns, the information may be displayed similarly to how it is shown in output 500. Output 500 may provide the substantially the same information as outputs 400A, 400B. In that regards, output 500 may include the judgment number, case number, date the judgment was entered, the type of action, the venue, a list of the creditors and debtors, the judgment or debt amount, the debt status, and/or additional information such as the attorney representing the creditors and/or debtors.

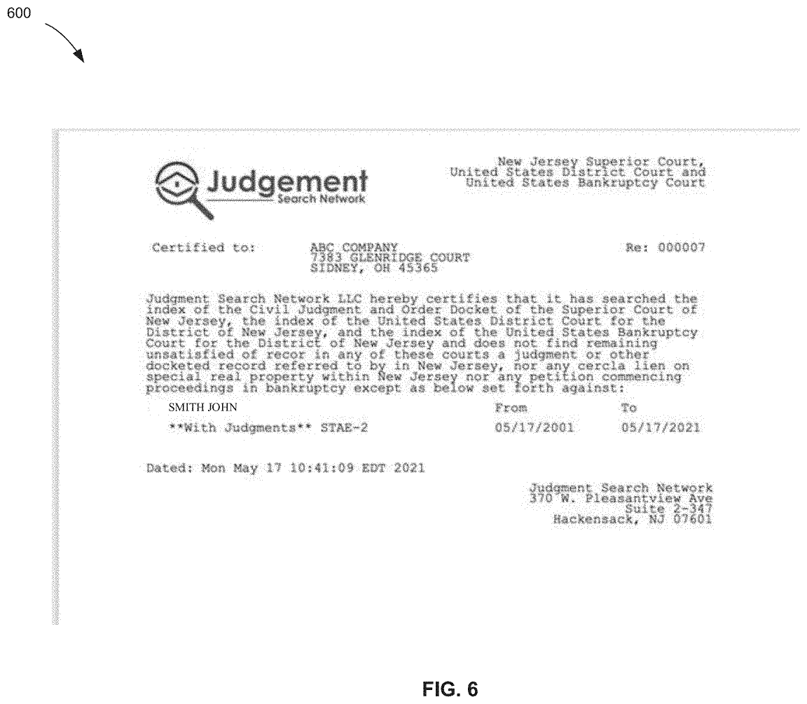

FIG. 6 illustrates a cover sheet that may be output in conjunction with outputs 400A, 400B, 500. The cover sheet may be a certification from the application identifying the databases that were searched when identifying the results in outputs 400A, 400B.

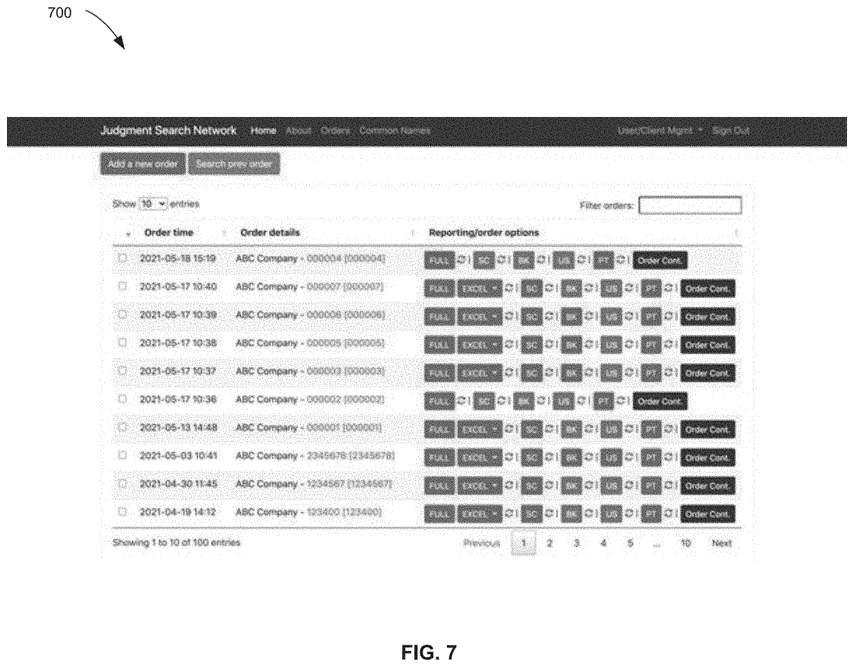

FIG. 7 illustrates a screen as part of the application that allows the user to view previous searches, or orders, that have been completed. For example, screen 700 allows the user to see when an order or search was placed, details regarding the order, and reporting/order options. Screen 700 also provides an input that allows the user to filter the orders to more easily find the order, or search, they are interested in. Some of the buttons and/or options shown on screen 700 are for administrative users only. The buttons and/or options that are shown to the administrators only may be used for troubleshooting issues with the application.

Some of the buttons and/or options shown on screen 700 are accessible to all users, such as “full,” which will output a full text searchable PDF or text document of the results, “excel,” which will output a spreadsheet of the results, and “order cont.,” which provides the user the option to order a continuation on a name that has previously been searched. Other buttons and/or options may link search results retrieved from various storage systems 260 into the PDF or text document and/or spreadsheet that is produced in response to selecting the “full” button and/or “excel” option.

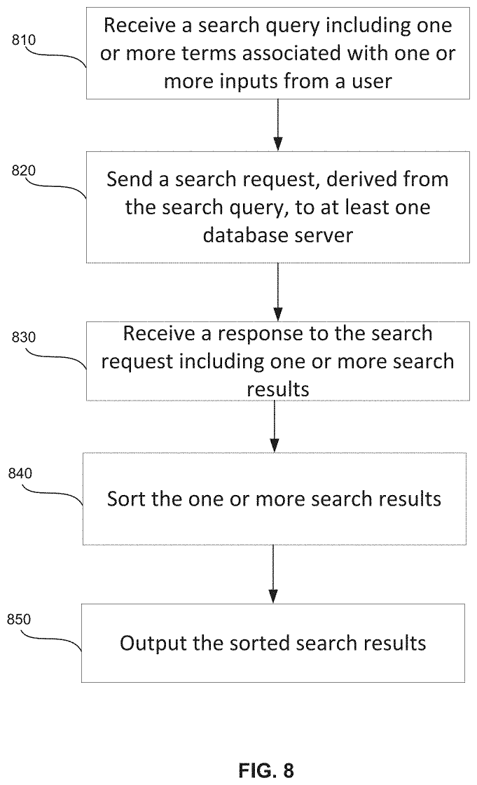

FIG. 8 illustrates a method of sending a search query and receiving an output of search results based on one or more search terms entered in the search query and variations for each of the search terms. The following operations do not have to be performed in the precise order described below. Rather, various operations can be handled in a different order or simultaneously, and operations may be added or omitted.

For example, in block 810, a device may receive a search request including one or more terms associated with one or more inputs from a user. The one or more terms may include a first name and a last name of a person of interest. In some examples, the terms may include a middle name, suffix, company name, address, city, state, zip code, search dates, name qualifier, and/or additional notes related to a person or business of interest.

In block 820, a search request, derived from the search query, may be sent to at least one database server. The search request may include one or more variations for each of the terms in the search request. A first input, such as a last name input, may have a first weight and a second input, such as a first name input, may have a second weight. The weight of the first input may be greater than the weight of the second input. A first term of the one or more terms may have a first score and a first variation of the first term may have a second score. For example, the information entered into last name input may have a first score and a variation of the information entered into last name input may have a second score. The first score may be greater than the second score. When the second score of the first variation is above a predetermined threshold, the first variation may be included in the search request. For example, each variation of the first term may receive a score. Only variations that have a score above the predetermined threshold may be included in the search request to create a more efficient and/or effective search request.

In block 830, the host device may receive a response to the search request including one or more search results. The one or more search results may include a match to the one or more terms in the search query. In some examples, the one or more search results may include a match to the one or variations of the one or more terms in the search query.

In block 840, the one or more search results may be weighted based on the first and second weights. For example, the one or more search results may be sorted such that those with a greater combined weight, or total weight of the first and second weights, are at the top of the search results.

In block 850, the sorted one or more search results may be output to the user. In some examples, the output may be a spreadsheet, a portable document format document, or a text document that is manipulable, filterable, searchable, and/or sortable by the user.

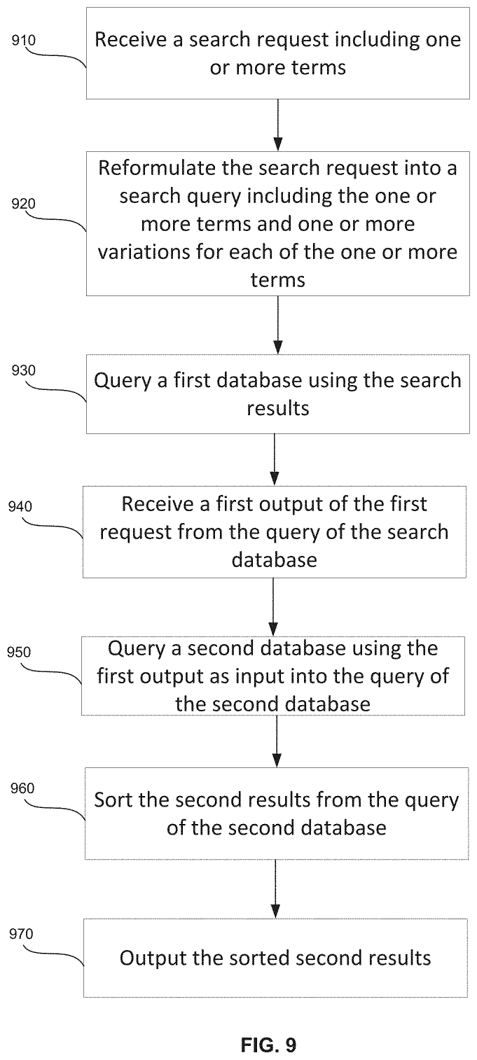

FIG. 9 illustrates a method of receiving a search query and outputting search results based on one or more search terms entered in the search query and variations for each of the search terms. The following operations do not have to be performed in the precise order described below. Rather, various operations can be handled in a different order or simultaneously, and operations may be added or omitted.

For example, in block 910 a server may receive a search request including one or more terms. The one or more terms may include a first name and a last name of a person of interest. In some examples, the terms may include a middle name, suffix, company name, address, city, state, zip code, search dates, name qualifier, and/or additional notes related to a person or business of interest.

In block 920, the search request may be reformulated into a search query including the one or more terms and one or more variations for each of the terms.

In block 920, a first database may be queried using the search query. For example, a first database may be searched based on the one or more terms and/or the one or more variations of the terms. Each of the one or more terms and each of the one or more variations may be assigned a score. For example, the term as entered may be assigned a score of 100 while the most common variation of the term may be assigned a score of 98, the next most common variation may be assigned a score of 96, etc. Each of the terms may be a type of terms. For example, a first term may be a first name and a second term may be a last name. Each type of term may be assigned a weight. For example, the first type of term may be assigned a first weight and the second type of term may be assigned a second weight. The weight assigned to each type of term may be predetermined. In some examples, the weight assigned to each type of term may be selected by a user.

In block 940, a first output of the first search results from the query of the first database is received by the server. The first output may identify the most relevant search results of the first database based on the score for each of the one or more terms and their variations. Additionally or alternatively, the first output may identify the most relevant search results of the first database based on the weight assigned to each type of term.

In block 950, the first output may be used as input for a query of a second database. The query of the second database may identify additional information pertaining to the person and/or business of interest associated with the first output. For example, the query of the second database may identify a name of a person of interest, an address of the person of interest, a filing location, a filing date, a case title, a docket number, a judgment number, a judgment type, or a judgment amount.

In block 960, the second results from the query of the second database may be sorted. In some examples, the second results may be sorted based on the score of each of the one or more terms and variations and/or the weight of each of the type of terms.

In block 970, the sorted second results may be output by the server. In some examples, the server may output, or transmit, the sorted second results to a user device. The output may be a spreadsheet, a portable document format document, or a text document.

The following numbered paragraphs describe features in accordance with various embodiments of the invention as further described above:

1. A method, comprising:

receiving, by one or more processors, a search query including one or more terms associated with one or more inputs from a user;

sending, by the one or more processors, a search request, derived from the search query, to at least one database server,
wherein the search request includes one or more variations for each of the terms in the search query,
wherein a first input of the one or more inputs has a first weight and a second input of the one or more inputs has a second weight, the first weight being greater than the second weight,
wherein a first term of the one or more terms has a first score and a first variation of the first term has a second score, the first score being greater than the second score, and
wherein when the second score of the first variation is above a predetermined threshold, the first variation is included in the search request;

receiving, by the one or more processors from the at least one database server, a response to the search request including one or more search results, wherein the one or more search results includes a match to the one or more terms in the search query;

sorting, by the one or more processors based on the first and second weights, the one or more search results; and

outputting, by the one or more processors, the sorted one or more search results.

2. The method of claim 1, wherein sending the search request to the at least one database server includes

sending, by the one or more processors, the search request to a first database server;

receiving, from the first database server, a first set of search results, wherein the first set of search results are used as input as a second search request at a second database server; and

receiving, by the one or more processors from the second database server, the response to the search request.

3. The method of claim 1, wherein the one or more terms includes a first name and a last name of a person of interest.

4. The method of claim 3, wherein the last name of the person of interest has a greater weight than the first name of the person of interest.

5. The method of claim 3, wherein the first name and the last name of the person of interest input into the search query has a greater weight than each of the variations of the first name and last name of the person of interest.

6. The method of claim 1, wherein the one or more terms includes a first name and a last name of a person of interest and the one or more search results includes a judgment against the person of interest.

7. The method of claim 6, wherein sending the search request to the at least one database server includes:

sending, by the one or more processors, the search request to a first database server, the search request including the first name and the last name of the person of interest and each of the variations of the first name and last name of the person of interest;

receiving, from the first database server, a first set of search results including the first name and last name of the person of interest, each of the variations of the first name and last name of the person of interest, and a judgment amount associated with the first name, last name, and each of the variations of the first name and last name of the person of interest, wherein the first set of search results are used as input as a second search request at a second database server; and

receiving, by the one or more processors from the second database server, a second set of search results including two or more of a filing location, a filing date, a case title, a docket number, a judgment number, a judgment type, and a judgment amount associated with the first name, last name, and each of the variations of the first name and last name of the person of interest, wherein the second set of search results corresponds to the one or more search results.

8. The method of claim 1, further comprising receiving, by the one or more processors, a user input to resort or filter the sorted one or more search results.

9. The method of claim 1, wherein the output sorted one or more search results is output as a spreadsheet, a portable document format document, or a text document.

10. The method of claim 1, wherein the sorted one or more search results includes at least one of a name of a person of interest, an address of the person of interest, a filing location, a filing date, a case title, a docket number, a judgment number, a judgment type, or a judgment amount.

11. A device, comprising:

one or more processors configured to:
receive a search query including one or more terms associated with one or more inputs from a user;
send a search request, derived from the search query, to at least one database server,
   wherein the search request includes one or more variations for each of the terms in the search query,
   wherein a first input of the one or more inputs has a first weight and a second input of the one or more inputs has a second weight, the first weight being greater than the second weight,
   wherein a first term of the one or more terms has a first score and a first variation of the first term has a second score, the first score being greater than the second score, and
   wherein when the second score of the first variation is above a predetermined threshold, the first variation is included in the search request;

receive, from the at least one database server, a response to the search request including one or more search results, wherein the one or more search results includes a match to the one or more terms in the search query;

sort, based on the first and second weights, the one or more search results; and

output, to a display, the sorted one or more search results.

12. The device of claim 11, wherein when sending the search request to the at least one database server, the one or more processors are further configured to:

send the search request to a first database server;

receive, from the first database server, a first set of search results, wherein the first set of search results are used as input as a second search request at a second database server; and

receive, from the second database server, the response to the search request.

13. The device of claim 1, wherein the one or more terms includes a first name and a last name of a person of interest.

14. The device of claim 13, wherein the last name of the person of interest has a greater weight than the first name of the person of interest.

15. The device of claim 13, wherein the first name and the last name of the person of interest input into the search query has a greater weight than each of the variations of the first name and last name of the person of interest.

16. The device of claim 1, wherein the one or more terms includes a first name and a last name of a person of interest and the one or more search results includes a judgment against the person of interest.

17. The device of claim 6, wherein when sending the search request to the at least one database server, the one or more processors are further configured to:

send the search request to a first database server, the search request including the first name and the last name of the person of interest and each of the variations of the first name and last name of the person of interest;

receive, from the first database server, a first set of search results including the first name and last name of the person of interest, each of the variations of the first name and last name of the person of interest, and a judgment amount associated with the first name, last name, and each of the variations of the first name and last name of the person of interest, wherein the first set of search results are used as input as a second search request at a second database server; and

receive, from the second database server, a second set of search results including two or more of a filing location, a filing date, a case title, a docket number, a judgment number, a judgment type, and a judgment amount associated with the first name, last name, and each of the variations of the first name and last name of the person of interest, wherein the second set of search results corresponds to the one or more search results.

18. The device of claim 1, further comprising receiving, by the one or more processors, a user input to resort or filter the sorted one or more search results.

19. The device of claim 1, wherein the output sorted one or more search results is output as a spreadsheet, a portable document format document, or a text document.

20. The device of claim 1, wherein the sorted one or more search results includes at least one of a name of a person of interest, an address of the person of interest, a filing location, a filing date, a case title, a docket number, a judgment number, a judgment type, or a judgment amount.

21. A method, comprising:

receiving, by one or more processors, a search request including one or more terms;

reformulating, by the one or more processors, the search request into a search query including the one or more terms and one or more variations for each of the terms;

querying, by the one or more processors, a first database using the search query,
wherein each of the one or more terms and each of the one or more variations is assigned a score, and
wherein each of the one or more terms is a type of term, each type of terms is assigned a weight;

receiving, by the one or more processors based on the score of each of the one or more terms and variations and the weight of each of the type of terms, a first output of first results from the query of the first database;

querying, by the one or more processors, a second database using the first output as input into the query of the second database;

sorting, by the one or more processors based on the score of each of the one or more terms and variations and the weight of each of the type of terms, second results from the query of the second database; and

outputting, by the one or more processors, the sorted second results.

22. The method of claim 21, wherein the one or more terms includes a first name and a last name of a person of interest.

23. The method of claim 22, wherein the last name of the person of interest has a greater weight than the first name of the person of interest.

24. The method of claim 22, wherein the first name and the last name of the person of interest has a greater score than each of the variations of the first name and last name of the person of interest.

25. The method of claim 24, wherein the one or more terms includes a first name and a last name of a person of interest and the sorted second results includes a judgment against the person of interest.

26. The method of claim 21, wherein the sorted second results is output as a spreadsheet, a portable document format document, or a text document.

27. The method of claim 21, wherein the sorted second results includes at least one of a name of a person of interest, an address of the person of interest, a filing location, a filing date, a case title, a docket number, a judgment number, a judgment type, or a judgment amount.

28. A device, comprising:

one or more processors configured to:
receive a search request including one or more terms;
reformulate the search request into a search query including the one or more terms and one or more variations for each of the terms;
query a first database using the search query,
   wherein each of the one or more terms and each of the one or more variations is assigned a score, and
   wherein each of the one or more terms is a type of term, each type of terms is assigned a weight;
receive, based on the score of each of the one or more terms and variations and the weight of each of the type of terms, a first output of first results from the query of the first database;
query a second database using the first output as input into the query of the second database;
sort, based on the score of each of the one or more terms and variations and the weight of each of the type of terms, second results from the query of the second database; and
output the sorted second results.

29. The device of claim 28, wherein the one or more terms includes a first name and a last name of a person of interest.

30. The device of claim 29, wherein the last name of the person of interest has a greater weight than the first name of the person of interest.

31. The device of claim 29, wherein the first name and the last name of the person of interest has a greater weight than each of the variations of the first name and last name of the person of interest.

32. The device of claim 31, wherein the one or more terms includes a first name and a last name of a person of interest and the sorted second results includes a judgment against the person of interest.

33. The device of claim 28, wherein the sorted second results is output as a spreadsheet, a portable document format document, or a text document.

34. The device of claim 28, wherein the sorted second results includes at least one of a name of a person of interest, an address of the person of interest, a filing location, a filing date, a case title, a docket number, a judgment number, a judgment type, or a judgment amount.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A method, comprising:
receiving, by one or more processors, a search query including one or more terms associated with one or more inputs from a user;
sending, by the one or more processors, a search request, derived from the search query, to at least one database server,
wherein the search request includes one or more variations for each of the terms in the search query,
wherein a first input of the one or more inputs has a first weight and a second input of the one or more inputs has a second weight, the first weight being greater than the second weight,
wherein a first term of the one or more terms has a first score and a first variation of the first term has a second score, the first score being greater than the second score, and
wherein when the second score of the first variation is above a predetermined threshold, the first variation is included in the search request;
receiving, by the one or more processors from the at least one database server, a response to the search request including one or more search results, wherein the one or more search results includes a match to the one or more terms in the search query;
sorting, by the one or more processors based on the first and second weights, the one or more search results; and
outputting, by the one or more processors, the sorted one or more search results.

2. The method of claim 1, wherein sending the search request to the at least one database server includes
sending, by the one or more processors, the search request to a first database server;
receiving, from the first database server, a first set of search results, wherein the first set of search results are used as input as a second search request at a second database server; and
receiving, by the one or more processors from the second database server, the response to the search request.

3. The method of claim 1, wherein the one or more terms includes a first name and a last name of a person of interest.

4. The method of claim 3, wherein the last name of the person of interest has a greater weight than the first name of the person of interest.

5. The method of claim 3, wherein the first name and the last name of the person of interest input into the search query has a greater weight than each of the variations of the first name and last name of the person of interest.

6. The method of claim 1, wherein the one or more terms includes a first name and a last name of a person of interest and the one or more search results includes a judgment against the person of interest.

7. The method of claim 6, wherein sending the search request to the at least one database server includes:
sending, by the one or more processors, the search request to a first database server, the search request including the first name and the last name of the person of interest and each of the variations of the first name and last name of the person of interest;
receiving, from the first database server, a first set of search results including the first name and last name of the person of interest, each of the variations of the first name and last name of the person of interest, and a judgment amount associated with the first name, last name, and each of the variations of the first name and last name of the person of interest, wherein the first set of search results are used as input as a second search request at a second database server; and
receiving, by the one or more processors from the second database server, a second set of search results including two or more of a filing location, a filing date, a case title, a docket number, a judgment number, a judgment type, and a judgment amount associated with the first name, last name, and each of the variations of the first name and last name of the person of interest, wherein the second set of search results corresponds to the one or more search results.

8. The method of claim 1, wherein the sorted one or more search results includes at least one of a name of a person of interest, an address of the person of interest, a filing location, a filing date, a case title, a docket number, a judgment number, a judgment type, or a judgment amount.

9. A device, comprising:
one or more processors configured to:
receive a search query including one or more terms associated with one or more inputs from a user;
send a search request, derived from the search query, to at least one database server,
wherein the search request includes one or more variations for each of the terms in the search query,
wherein a first input of the one or more inputs has a first weight and a second input of the one or more inputs has a second weight, the first weight being greater than the second weight,
wherein a first term of the one or more terms has a first score and a first variation of the first term has a second score, the first score being greater than the second score, and
wherein when the second score of the first variation is above a predetermined threshold, the first variation is included in the search request;
receive, from the at least one database server, a response to the search request including one or more search results, wherein the one or more search results includes a match to the one or more terms in the search query;
sort, based on the first and second weights, the one or more search results; and
output, to a display, the sorted one or more search results.

10. The device of claim 9, wherein when sending the search request to the at least one database server, the one or more processors are further configured to:
send the search request to a first database server;
receive, from the first database server, a first set of search results, wherein the first set of search results are used as input as a second search request at a second database server; and
receive, from the second database server, the response to the search request.

11. The device of claim 9, wherein the one or more terms includes a first name and a last name of a person of interest and the one or more search results includes a judgment against the person of interest.

12. The device of claim 11, wherein when sending the search request to the at least one database server, the one or more processors are further configured to:
send the search request to a first database server, the search request including the first name and the last name of the person of interest and each of the variations of the first name and last name of the person of interest;
receive, from the first database server, a first set of search results including the first name and last name of the person of interest, each of the variations of the first name and last name of the person of interest, and a judgment amount associated with the first name, last name, and each of the variations of the first name and last name of the person of interest, wherein the first set of search results are used as input as a second search request at a second database server; and
receive, from the second database server, a second set of search results including two or more of a filing location, a filing date, a case title, a docket number, a judgment number, a judgment type, and a judgment amount associated with the first name, last name, and each of the variations of the first name and last name of the person of interest, wherein the second set of search results corresponds to the one or more search results.

13. The device of claim 9, further comprising receiving, by the one or more processors, a user input to resort or filter the sorted one or more search results.

14. A method, comprising:
receiving, by one or more processors, a search request including one or more terms;
reformulating, by the one or more processors, the search request into a search query including the one or more terms and one or more variations for each of the terms;
querying, by the one or more processors, a first database using the search query,
wherein each of the one or more terms and each of the one or more variations is assigned a score, and
wherein each of the one or more terms is a type of term, each type of terms is assigned a weight;
receiving, by the one or more processors based on the score of each of the one or more terms and variations and the weight of each of the type of terms, a first output of first results from the query of the first database;
querying, by the one or more processors, a second database using the first output as input into the query of the second database;
sorting, by the one or more processors based on the score of each of the one or more terms and variations and the weight of each of the type of terms, second results from the query of the second database; and
outputting, by the one or more processors, the sorted second results.

15. The method of claim 4, wherein the one or more terms includes a first name and a last name of a person of interest.

16. The method of claim 15, wherein the last name of the person of interest has a greater weight than the first name of the person of interest.

17. The method of claim 15, wherein the first name and the last name of the person of interest has a greater weight than each of the variations of the first name and last name of the person of interest.

18. The method of claim 17, wherein the one or more terms includes a first name and a last name of a person of interest and the sorted second results includes a judgment against the person of interest.

19. The method of claim 13, wherein the sorted second results is output as a spreadsheet, a portable document format document, or a text document.

20. The method of claim 13, wherein the sorted second results includes at least one of a name of a person of interest, an address of the person of interest, a filing location, a filing date, a case title, a docket number, a judgment number, a judgment type, or a judgment amount.
